(19) United States
(12) Patent Application Publication
(10) Pub. No.: US 2022/0238993 A1
(43) Pub. Date: Jul. 28, 2022

(54) CASING DEVICE, AND REMOTE CONTROL SYSTEM

(71) Applicant: KABUSHIKI KAISHA TOKAI RIKA DENKI SEISAKUSHO, Aichi (JP)

(72) Inventors: Masanori KOSUGI, Aichi (JP); Junji MURASE, Aichi (JP)

(73) Assignee: KABUSHIKI KAISHA TOKAI RIKA DENKI SEISAKUSHO, Aichi (JP)

(21) Appl. No.: 17/582,352

(22) Filed: Jan. 24, 2022

(30) Foreign Application Priority Data
Jan. 27, 2021 (JP) 2021-011057

(51) Int. Cl. H01Q 1/42; H01Q 1/24

(52) U.S. Cl. CPC H01Q 1/42; H01Q 1/243

(57) ABSTRACT

A casing has a housing section adapted to house an electronic key. The casing is formed of a material capable of blocking a particular frequency band. A controller is configured to cause an actuator to actuate a movable portion of the electronic key to transmit a signal for controlling a controlled device with the particular frequency band while switching a part of the casing into a state that the signal is allowed to pass, in a case where a transceiver receives a trigger signal from a mobile device.

### FIELD

The presently disclosed subject matter relates to a casing device adapted to be disposed in a prescribed space in order to house an electronic key to be remotely controlled. The presently disclosed subject matter also relates to a remote control system including the casing device.

### BACKGROUND

European Patent Publication No. 3418985A1 discloses a casing device adapted to be disposed in a vehicle cabin opened and closed by a door of a vehicle. The casing device includes a housing section, a transceiver, and an actuator. The housing section houses an electronic key. The electronic key is a device configured to cause a control device installed in the vehicle to control a locking/unlocking device configured to lock/unlock the door through wireless communication when a specific operation is performed. When the transceiver receives a locking/unlocking instruction from a mobile device adapted to be carried by a user, the actuator performs the specific operation described above with respect to the electronic key. As a result, in a state that the electronic key is left in the vehicle cabin, it is possible to remotely control the operation of the locking/unlocking device with the mobile device from, for example, the outside of the vehicle cabin.

### SUMMARY

It is demanded to improve the security of a casing device adapted to be disposed in a prescribed space in order to house an electronic key to be remotely controlled.

In order to meet the demand described above, one illustrative aspect of the presently disclosed subject matter provides a casing device adapted to be disposed in a prescribed space that is opened/closed by an opening/closing body, comprising:

a casing having a housing section adapted to house an electronic key configured to cause a control device to perform control of a controlled device based on first wireless communication including reception of a first signal using a first frequency band and transmission of a second signal using a second frequency band as a response to the first signal, and being formed of a material capable of blocking the second frequency band;

an actuator configured to actuate a movable portion of the electronic key housed in the housing section;

a transceiver configured to receive, based on second wireless communication, a trigger signal from a mobile device adapted to be carried by a user; and

a controller configured to control an operation of the actuator,

wherein a part of the casing is configured to be switchable between a state that the second signal is allowed to pass and a state that the second signal is not allowed to pass; and

wherein the controller is configured to switch the part of the casing into the state that the second signal is allowed to pass, and to cause the actuator to actuate the movable portion so as to cause the electronic key to transmit the second signal, in a case where the transceiver receives the trigger signal.

In order to meet the demand described above, one illustrative aspect of the presently disclosed subject matter provides a remote control system, comprising:

a casing device adapted to be disposed in a prescribed space that is opened/closed by an opening/closing body;

a control device configured to perform control of a controlled device; and

an electronic key configured to cause the control device to perform the control of the controlled device based on first wireless communication including reception of a first signal using a first frequency band and transmission of a second signal using a second frequency band as a response to the first signal,

wherein the casing device includes:
a casing having a housing section adapted to house the electronic key, and being formed of a material capable of blocking the second frequency band;
an actuator configured to actuate a movable portion of the electronic key housed in the housing section;
a transceiver configured to receive, based on second wireless communication, a trigger signal from a mobile device adapted to be carried by a user; and
a controller configured to control an operation of the actuator,

wherein a part of the casing is configured to be switchable between a state that the second signal is allowed to pass and a state that the second signal is not allowed to pass; and

wherein the controller is configured to switch the part of the casing into the state that the second signal is allowed to pass, and to cause the actuator to actuate the movable portion so as to cause the electronic key to transmit the second signal, in a case where the transceiver receives the trigger signal.

With the configuration according to each of the above aspects until the trigger signal from the mobile device is received by the transceiver, the casing can be brought in a state that the second signal is not allowed to pass. Accordingly, even if the second signal is transmitted by unexpectedly receiving the first signal from the electronic key housed in the casing device, it is possible to prevent the control device from performing the operation control of the controlled device. In other words, it is possible to reduce a possibility that the controlled device is unexpectedly operated in the state that the electronic key is housed in the casing device disposed in the prescribed space. Accordingly, it is possible to improve the security of the casing device adapted to be disposed in the prescribed space in order to house the electronic key to be remotely controlled. It is also possible to improve the security of the remote control system including the casing device.

### BRIEF DESCRIPTION OF DRAWINGS

FIG. 1 illustrates a configuration of a remote control system according to an embodiment.

FIG. 2 illustrates an exemplary configuration of a casing device of FIG. 1.

FIG. 3 illustrates of an operation of the casing device of FIG. 2.

FIG. 4 illustrates a specific configuration of a controller of FIG. 2.

FIG. 5 illustrates a flow of processing to be executed by the controller of FIG. 4.

FIG. 6 illustrates another exemplary configuration of the casing device of FIG. 1.

FIG. 7 illustrates of an operation of the casing device of FIG. 6.

FIG. 8 illustrates a specific configuration of a controller of FIG. 6.

FIG. 9 illustrates a flow of processing to be executed by the controller of FIG. 8.

### DESCRIPTION OF EMBODIMENTS

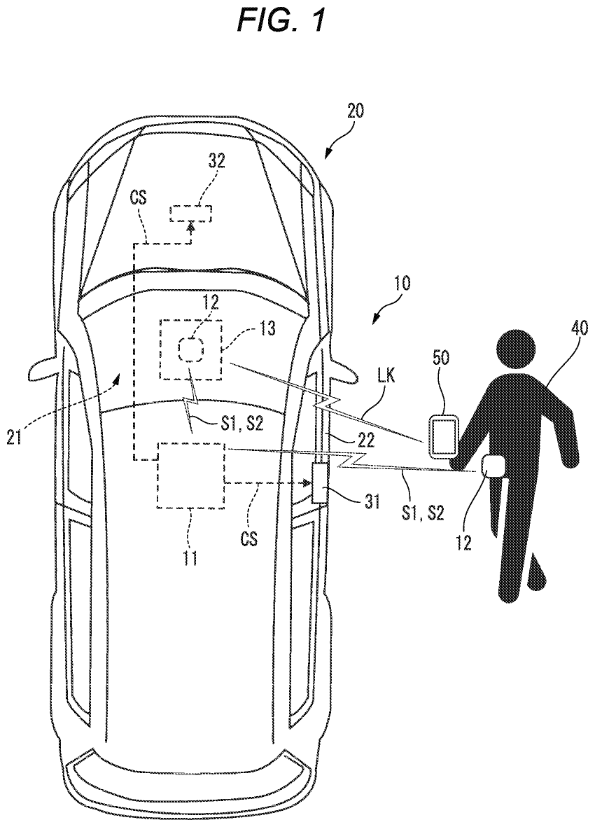

Exemplary embodiments will be described in detail below with reference to the accompanying drawings. FIG. 1 illustrates a configuration of a remote control system 10 according to an embodiment. In each of the drawings, the scale is appropriately changed in order to make each element illustrated have a recognizable size.

The remote control system 10 includes a control device 11. The control device 11 is installed in a vehicle 20. The control device 11 is configured to control the operation of a locking/unlocking device 31 installed in the vehicle 20. The locking/unlocking device 31 is a device configured to lock/unlock a door 22 for opening/closing a vehicle cabin 21 of the vehicle 20. The vehicle 20 is an example of a mobile entity. The vehicle cabin 21 is an example of the prescribed space. The door 22 is an example of an opening/closing body. The locking/unlocking device 31 is an example of a controlled device.

The remote control system 10 includes an electronic key 12. The electronic key 12 is a device adapted to be carried by a user 40. The electronic key 12 is a device capable of causing the control device 11 to control the operation of the locking/unlocking device 31 based on first wireless communication. The first wireless communication includes transmitting and receiving a first signal S1 using a first frequency band and a second signal S2 using a second frequency band. The first frequency band and the second frequency band are different from each other. Examples of the first frequency band include a low frequency (LF) band. Examples of the second frequency band include an ultra high frequency (UHF) band.

Specifically, the control device 11 transmits the first signal S1 through a communication device disposed at an appropriate position in the vehicle 20. The transmission of the first signal S1 may be performed continuously or intermittently. The electronic key 12 includes a communication device including an antenna capable of receiving the first signal S1 and transmitting the second signal S2. The electronic key 12 is configured to transmit the second signal S2 upon receiving the first signal S1. The second signal S2 is configured to include authentication information required for the authentication of the electronic key 12. The authentication information is information capable of specifying at least one of the electronic key 12 and the user 40.

The control device 11 is configured to execute authentication processing upon reception of the second signal S2 through a communication device disposed at an appropriate position in the vehicle 20. Specifically, the control device 11 is configured to match the authentication information included in the second signal S2 with authentication information of the electronic key 12 stored in a storage device (not illustrated) in advance. When the matching degree between the two pieces of information exceeds a threshold value, the control device 11 determines that the authentication of the electronic key 12 is succeeded.

When it is determined that the authentication of the electronic key 12 is succeeded, the control device 11 is configured to output a control signal CS for causing the locking/unlocking device 31 to perform the locking/unlocking operation. For example, the locking/unlocking device 31 may be configured to perform the locking/unlocking of the door 22 when the user 40 touches a touch sensor provided on the door handle in a state that the authentication of the electronic key 12 is succeeded.

That is, when the user 40 carrying the electronic key 12 enters an area capable of receiving the first signal S1, the authentication of the electronic key 12 is performed through the first wireless communication. When the authentication is succeeded, the user 40 can lock/unlock the door 22 without performing an operation such as inserting and rotating a key into a key cylinder.

The remote control system 10 includes a casing device 13. The casing device 13 is configured to be disposed in the vehicle cabin 21 of the vehicle 20. The casing device 13 is configured to house the electronic key 12. That is, the electronic key 12 can be disposed in the vehicle cabin 21.

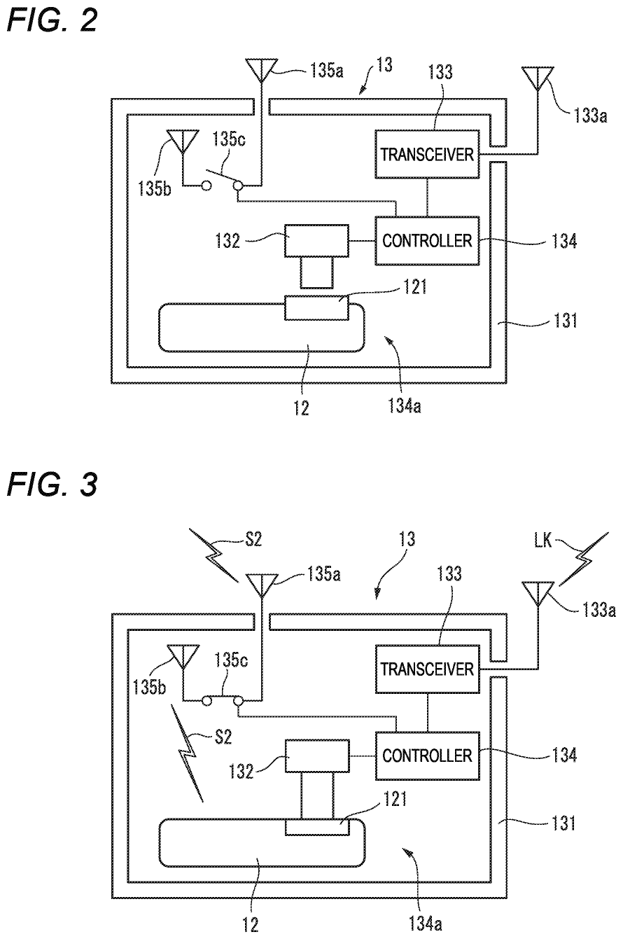

FIG. 2 illustrates an exemplary configuration of the casing device 13. The casing device 13 includes a casing 131. The casing 131 includes a housing section 131a in which the electronic key 12 is housed. The casing 131 is formed of a material capable of blocking the second frequency band.

The casing device 13 includes an actuator 132. The actuator 132 is configured to actuate a movable portion 121 of the electronic key 12 housed in the housing section 131a. The electronic key 12 is configured to transmit the second signal S2 regardless of the reception state of the first signal S1 when a prescribed operation is performed with respect to the movable portion 121. The movable portion 121 can be implemented by a button, a lever, or the like. The actuator 132 may be implemented by a solenoid, a cam mechanism, a rack-and-pinion mechanism, or the like. Examples of the actuation of the movable portion 121 for causing the electronic key 12 to transmit the second signal S2 include N-times repetitive depressions and the like.

The casing device 13 includes a transceiver 133. The transceiver 133 is configured to perform second wireless communication with a mobile device 50. As illustrated in FIG. 1, the mobile device 50 is a device adapted to be carried by the user 40. Examples of the mobile device 50 include a general-purpose portable information terminal such as a smartphone.

In this example, the second wireless communication is short-range wireless communication performed with the second frequency band. As illustrated in FIG. 2, the transceiver 133 includes an antenna 133a capable of receiving a signal in the second frequency band. As described above, since the casing 131 is formed of a material capable of blocking the second frequency band, the transceiver 133 is configured such that at least the antenna 133a is disposed outside the casing 131.

As used herein, the term “short-range wireless communication” means wireless communication performed in accordance with standard IEEE 802.15 or IEEE 802.11. Examples of the technology capable of executing such wireless communication include Bluetooth (registered trademark), Bluetooth Low Energy (registered trademark), UWB (Ultra Wide Band), ZigBee (registered trademark), and Wi-Fi (registered trademark). As used herein, the term “short-range wireless communication” is distinguished from “near field wireless communication” performed with a non-contact communication technique in which a mobile device transmits information upon reception of minute power from a radio wave transmitted from a reading device. Examples of the technique capable of executing the near field wireless communication include an RF-ID and an NFC.

When it is desired to lock/unlock the door 22 of the vehicle 20 in a state that the electronic key 12 is housed in the casing device 13, the user 40 performs a prescribed operation with respect to the mobile device 50. As illustrated in FIG. 1, the mobile device 50 is configured to transmit a lock/unlock signal LK based on the prescribed operation. The lock/unlock signal LK is an example of a trigger signal.

As illustrated in FIG. 2, the casing device 13 includes a controller 134. The controller 134 is configured to control the operation of the actuator 132. Specifically, as illustrated in FIG. 3, the controller 134 is configured to cause the actuator 132 to perform an actuation of the movable portion 121 for causing the electronic key 12 to transmit the second signal S2 when the transceiver 133 receives the lock/unlock signal LK. In brief, when the transceiver 133 receives the lock/unlock signal LK, the second signal S2 is transmitted from the electronic key 12.

The casing device 13 includes a first antenna 135a, a second antenna 135b, and a switch 135c. Each of the first antenna 135a and the second antenna 135b has sensitivity in the second frequency band. The first antenna 135a is disposed outside the casing 131. The second antenna 135b is disposed inside the casing 131. The switch 135c is configured to switch between a state that the first antenna 135a and the second antenna 135b are electrically connected and a state that the first antenna 135a and the second antenna 135b are electrically insulated. In an initial state illustrated in FIG. 2, the switch 135c causes the first antenna 135a and the second antenna 135b to be in an electrically isolated state.

The casing 131 includes a conductive path 131b formed by electrically connecting the first antenna 135a and the second antenna 135b. As illustrated in FIG. 3, the controller 134 is configured to cause the switch 135c to be in a state that the first antenna 135a and the second antenna 135b are electrically connected when the transceiver 133 receives the lock/unlock signal LK. In other words, the controller 134 is configured to cause the switch 135c to form the conductive path 131b when the transceiver 133 receives the lock/unlock signal LK.

When the conductive path 131b is formed, the second signal S2 transmitted from the electronic key 12 is received by the second antenna 135b disposed inside the casing 131, and is transmitted from the first antenna 135a disposed outside the casing 131 to the control device 11. In other words, the casing device 13 is brought in a state that the second signal S2 is allowed to pass through the conductive path 131b that is a part of the casing 131. As described above, when the second signal S2 is received, the control device 11 performs the authentication processing of the electronic key 12, and outputs the control signal CS for controlling the operation of the locking/unlocking device 31.

Accordingly, when the user 40 transmits the lock/unlock signal LK from the mobile device 50 in the state that the electronic key 12 is housed in the casing device 13 disposed in the vehicle cabin 21, the door 22 can be locked/unlocked. In other words, the user 40 can lock/unlock the door 22 by the prescribed operation with respect to the mobile device 50 from outside the vehicle cabin 21 without carrying the electronic key 12.

According to the configuration of the present embodiment, until the lock/unlock signal LK from the mobile device 50 is received by the transceiver 133, the casing 131 can be brought in a state that the second signal S2 is not allowed to pass. Accordingly, even if the second signal S2 is transmitted by unexpectedly receiving the first signal S1 from the electronic key 12 housed in the casing device 13, it is possible to prevent the control device 11 from performing the operation control of the locking/unlocking device 31. In other words, it is possible to reduce a possibility that the door 22 is unexpectedly locked/unlocked in the state that the electronic key 12 is housed in the casing device 13 disposed in the vehicle cabin 21. Accordingly, it is possible to improve the security of the casing device 13 adapted to be disposed in the vehicle cabin 21 in order to house the electronic key 12 to be remotely controlled. It is also possible to improve the security of the remote control system 10 including the casing device 13.

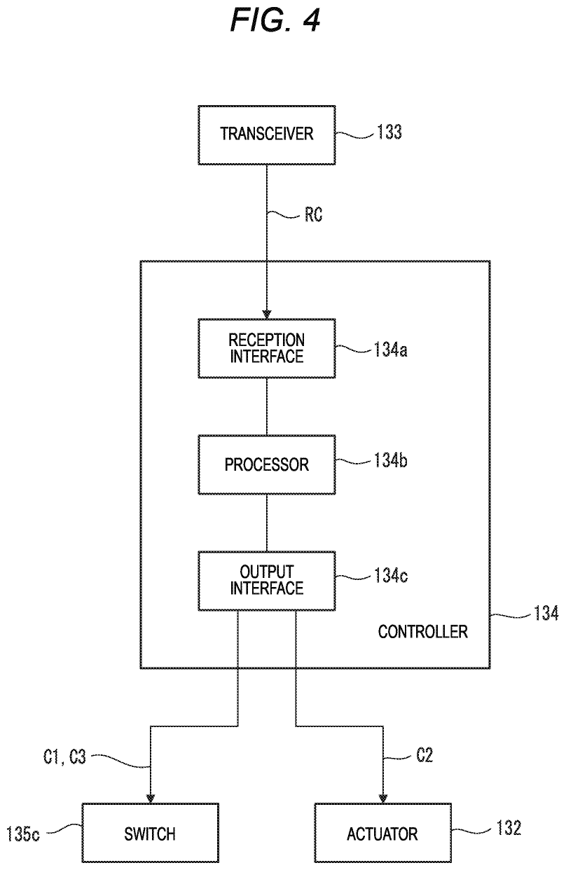

FIG. 4 illustrates a more specific configuration of the controller 134 of the casing device 13 configured as described above. The controller 134 includes a reception interface 134a, a processor 134b, and an output interface 134c.

The reception interface 134a is configured as an interface capable of receiving a reception signal RC indicating that the lock/unlock signal LK transmitted from the mobile device 50 is received by the transceiver 133. Instead of the reception signal RC, the lock/unlock signal LK itself may be inputted to the reception interface 134a.

The processor 134b is configured to output, from the output interface 134c, a first control signal C1 for causing the switch 135c to form the conductive path 131b when the reception interface 134a receives the reception signal RC.

In addition, the processor 134b is configured to output, from the output interface 134c, a second control signal C2 for causing the actuator 132 to perform an actuation of the movable portion 121 for causing the electronic key 12 to transmit the second signal S2 when the reception interface 134a receives the reception signal RC.

In brief, the output interface 134c is configured as an interface for outputting a signal for causing the actuator 132 and the switch 135c to perform desired operations.

The processor 134b having the above-described function can be implemented by a processing element such as a microcontroller.

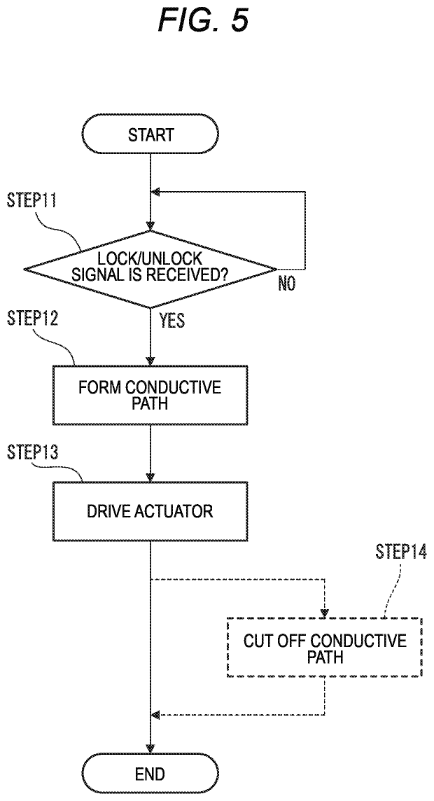

FIG. 5 illustrates a flow of processing to be executed by the processor 134b of the controller 134 configured as described above.

The processor 134b determines whether the transceiver 133 receives the lock/unlock signal LK from the mobile device 50 (STEP11). The processing is repeated until it is determined that the lock/unlock signal LK is received (NO in STEP11).

When it is determined that the lock/unlock signal LK is received (YES in STEP11), the processor 134b outputs, from the output interface 134c, the first control signal C1 for causing the switch 135c to form the conductive path 131b (STEP12). As a result, a portion of the casing 131 is brought into a state that the second signal S2 is allowed to pass.

Subsequently, the processor 134b outputs, from the output interface 134c, the second control signal C2 for causing the actuator 132 to operate the movable portion 121 of the electronic key 12 (STEP13). As a result, the second signal S2 is transmitted from the electronic key 12. The second signal S2 is transmitted to the outside of the casing device 13 through the conductive path 131b, and is received by the control device 11. The control device 11 having received the second signal S2 causes the locking/unlocking device 31 to perform the locking/unlocking operation of the door 22.

The order in which the processing as for STEP12 and the processing as for STEP13 are performed may be reversed, or both processing may be performed in parallel.

As illustrated in FIG. 4, the processor 134b may be configured to output a third control signal C3 for causing the switch 135c to cut off the conductive path 131b. The switch 135c that receives the third control signal C3 causes the first antenna 135a and the second antenna 135b to be in an electrically isolated state. As a result, the casing 131 is brought into a state that the second signal S2 is not allowed to pass.

In this case, as illustrated in FIG. 5, the processor 134b may output, from the output interface 134c, the third control signal C3 for causing the switch 135c to cut off the conductive path 131b after causing the actuator 132 to perform the actuation of the movable portion 121 for causing the electronic key 12 to transmit the second signal S2 (STEP14).

According to such a configuration, it is possible to bring the casing 131 into a state that the second signal S2 is allowed to pass for a minimum time length required for causing the locking/unlocking device 31 to perform the locking/unlocking of the door 22. As a result, it is possible to further reduce a possibility that the door 22 is locked/unlocked by the electronic key 12 housed in the casing device 13 unexpectedly receiving the first signal S1.

The second signal S2 transmitted from the electronic key 12 can also be used for causing the control device 11 to perform the operation control of another controlled device installed in the vehicle 20. As illustrated in FIG. 1, another example of the controlled device includes an activator 32. The activator 32 is a device for activating a driving source of the vehicle 20. The driving source may be a combustion engine or an electric motor.

For example, the first signal S1 may be transmitted from a communication device disposed at an appropriate position in the vehicle 20 when the user 40 seated in a driver's seat steps on a brake pedal. When the electronic key 12 receives the first signal S1, the electronic key 12 transmits the second signal S2 as a response. When the second signal S2 is received by the control device 11, the authentication processing of the electronic key 12 is performed as described above. The control device 11 may be configured to output a control signal CS for causing the activator 32 installed in the vehicle 20 to activate the driving source when the user 40 touches, for example, an ignition switch in a state that the authentication of the electronic key 12 is succeeded.

In this case, it is not necessary to cause the switch 135c to cut off the conductive path 131b after the operation control of the actuator 132 for causing the locking/unlocking device 31 to perform the locking/unlocking of the door 22 is performed. In addition, the casing 131 can be formed of a material allowing the first frequency band to permeate. In this case, since the casing 131 constantly allows the first signal S1 to pass, the operation of the controlled device such as the activator 32 can be controlled in a state that the electronic key 12 is housed in the casing 131.

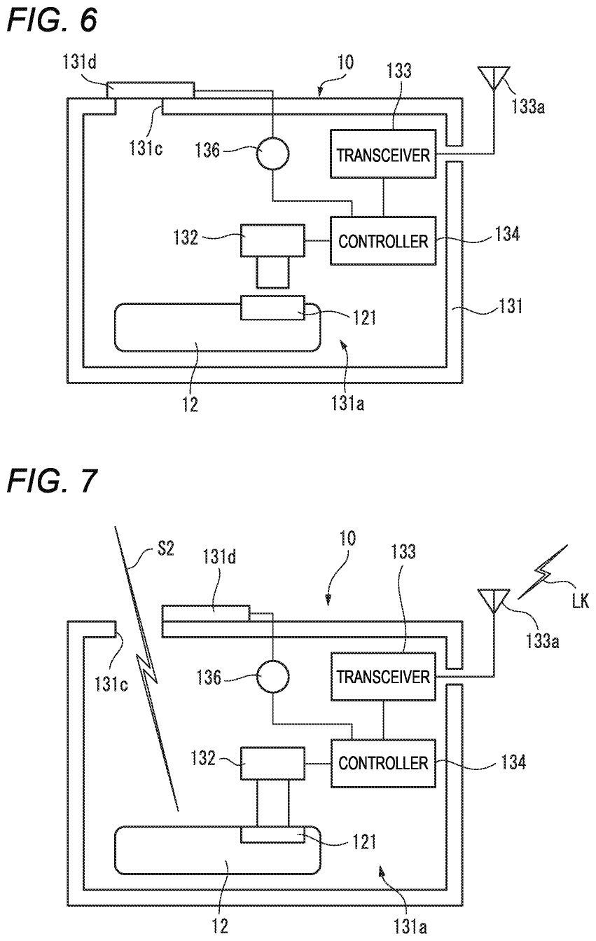

FIG. 6 illustrates another exemplary configuration of the casing device 13. Components substantially the same as those in the configuration described with reference to FIG. 2 are assigned with the same reference numerals, and repetitive descriptions for those will be omitted.

The casing 131 of the casing device 13 according to the present example includes an aperture 131c and a lid 131d. The lid 131d is configured to be movable between a position for opening the aperture 131c and a position for closing the aperture 131c. In the initial state, the lid 131d closes the aperture 131c. The lid 131d is formed of a material capable of blocking the second frequency band.

The casing device 13 according to the present example includes an opening/closing mechanism 136. The opening/closing mechanism 136 is a mechanism for displacing the lid 131d between the position for opening the aperture 131c and the position for closing the aperture 131c. The opening/closing mechanism 136 can be implemented by a solenoid, a cam mechanism, a rack-and-pinion mechanism, or the like.

As illustrated in FIG. 7, the controller 134 is configured to cause the actuator 132 to actuate the movable portion 121 of the electronic key 12 when the transceiver 133 receives the lock/unlock signal LK, so as to cause the opening/closing mechanism 136 to displace the lid 131d to the position where the aperture 131c is opened.

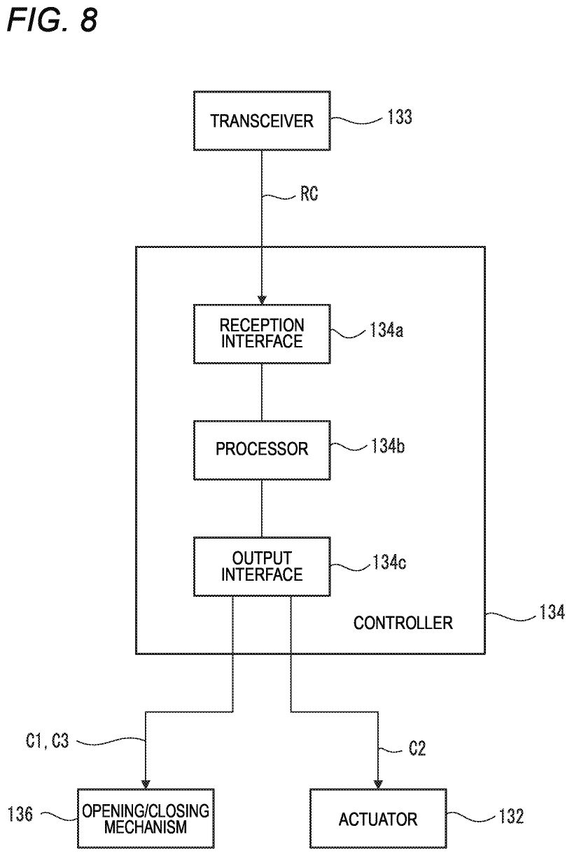

More specifically, as illustrated in FIG. 8, the processor 134b of the controller 134 is configured to output, from the output interface 134c, a first control signal C1 for causing the opening/closing mechanism 136 to displace the lid 131d to the position for opening the aperture 131c when the reception interface 134a receives the reception signal RC.

As illustrated in FIG. 7, the second signal S2 is transmitted from the electronic key 12 by the actuation of the movable portion 121 by the actuator 132. The second signal S2 exits the casing 131 through the aperture 131c and is received by the control device 11. That is, the casing device 13 is brought in a state that the second signal S2 is allowed to pass through the aperture 131c that is a part of the casing 131. As described above, when the second signal S2 is received, the control device 11 performs the authentication processing of the electronic key 12, and outputs the control signal CS for controlling the operation of the locking/unlocking device 31.

Even with the configuration according to the present example, until the lock/unlock signal LK from the mobile device 50 is received by the transceiver 133, the casing 131 can be brought in a state that the second signal S2 is not allowed to pass. Accordingly, even if the second signal S2 is transmitted by unexpectedly receiving the first signal S1 from the electronic key 12 housed in the casing device 13, it is possible to prevent the control device 11 from performing the operation control of the locking/unlocking device 31. In other words, it is possible to reduce a possibility that the door 22 is unexpectedly locked/unlocked in the state that the electronic key 12 is housed in the casing device 13 disposed in the vehicle cabin 21. Accordingly, it is possible to improve the security of the casing device 13 adapted to be disposed in the vehicle cabin 21 in order to house the electronic key 12 to be remotely controlled. It is also possible to improve the security of the remote control system 10 including the casing device 13.

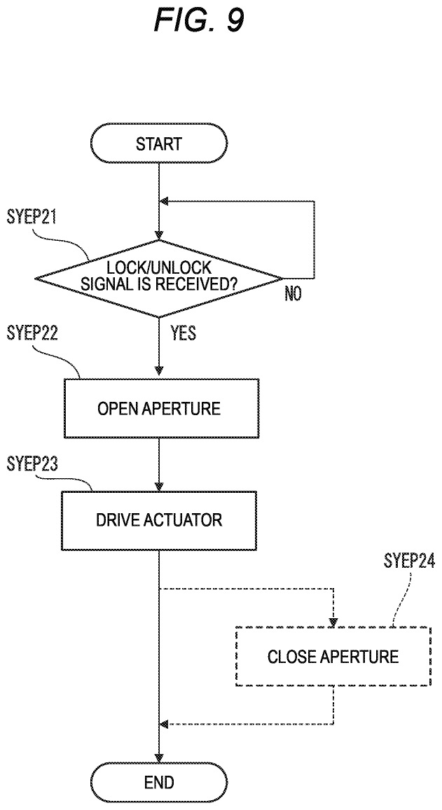

FIG. 9 illustrates a flow of processing to be executed by the processor 134b of the controller 134 according to the present example.

The processor 134b determines whether the transceiver 133 receives the lock/unlock signal LK from the mobile device 50 (STEP21). The processing is repeated until it is determined that the lock/unlock signal LK is received (NO in STEP21).

When it is determined that the lock/unlock signal LK is received (YES in STEP21), the processor 134b outputs, from the output interface 134c, the first control signal C1 for causing the opening/closing mechanism 136 to displace the lid 131d to the position for opening the aperture 131c (STEP22). As a result, a portion of the casing 131 is brought into a state that the second signal S2 is allowed to pass.

Subsequently, the processor 134b outputs, from the output interface 134c, the second control signal C2 for causing the actuator 132 to actuate the movable portion 121 of the electronic key 12 (STEP23). As a result, the second signal S2 is transmitted from the electronic key 12. The second signal S2 is transmitted to the outside of the casing device 13 through the aperture 131c, and is received by the control device 11. The control device 11 having received the second signal S2 causes the locking/unlocking device 31 to perform the locking/unlocking operation of the door 22.

The order in which the processing as for STEP22 and the processing as for STEP23 are performed may be reversed, or both processing may be performed in parallel.

As illustrated in FIG. 8, the processor 134b may be configured to output a third control signal C3 for causing the opening/closing mechanism 136 to displace the lid 131d to the position where the aperture 131c is closed. The opening/closing mechanism 136 having received the third control signal C3 causes the lid 131d to close the aperture 131c. As a result, the casing 131 is brought into a state that the second signal S2 is not allowed to pass.

In this case, as illustrated in FIG. 9, the processor 134b may output, from the output interface 134c, a third control signal C3 for causing the opening/closing mechanism 136 to displace the lid 131d to the position for closing the aperture 131c after causing the actuator 132 to perform the actuation of the movable portion 121 for causing the electronic key 12 to transmit the second signal S2 (STEP24).

According to such a configuration, it is possible to bring the casing 131 into a state that the second signal S2 is allowed to pass for a minimum time length required for causing the locking/unlocking device 31 to perform the locking/unlocking of the door 22. As a result, it is possible to further reduce a possibility that the door 22 is locked/unlocked by the electronic key 12 housed in the casing device 13 unexpectedly receiving the first signal S1.

The above embodiments are merely illustrative for facilitating understanding of the gist of the presently disclosed subject matter. The configuration according to each of the above embodiments can be appropriately modified or changed without departing from the gist of the presently disclosed subject matter.

In the above embodiment, the second wireless communication performed between the mobile device 50 and the transceiver 133 is the short-range wireless communication. In this case, it is possible to enhance the degree of freedom as for the position where the casing device 13 is disposed in the vehicle cabin 21.

However, the second wireless communication may be the near field wireless communication. When the near field wireless communication without using the second frequency band is performed, the antenna 133a of the transceiver 133 can be housed in the casing 131.

In the above embodiment, the electronic key 12 housed in the casing device 13 is remotely controlled based on the lock/unlock signal LK transmitted from the mobile device 50, so that the locking/unlocking of the door 22 of the vehicle 20 by the locking/unlocking device 31 is performed. As a result, it is possible to improve the security of the vehicle cabin 21 opened and closed by the door 22. In addition, it is possible to improve the security of the vehicle 20 as the mobile entity that is relatively easy to be subjected to theft.

However, the mobile entity on which the control device 11 and the locking/unlocking device 31 are installed is not limited to the vehicle 20. Examples of the mobile entity include railways, aircrafts, and ships. The mobile entity may not require a driver.

In addition, the opening/closing body to be locked/unlocked by the locking/unlocking device is not limited to the door 22 of the vehicle 20. Doors and windows in houses and facilities may also be an example of the opening/closing body. In this case, it is possible to enhance the security of a prescribed space opened and closed by the opening/closing body.

The controlled device controlled by the second signal S2 transmitted from the electronic key 12 through the remote control from the mobile device 50 is not limited to the locking/unlocking device 31 installed in the vehicle 20. The operation of the above-described activator 32 of the vehicle 20, a security device, a lighting device, an air conditioner, and an audio-visual equipment in the vehicle 20 or the above-described house or facility can be appropriately controlled. The signal transmitted from the mobile device 50 for causing each of these controlled devices to operate may be an example of the trigger signal.

The present application is based on Japanese Patent Application No. 2021-011057 filed on Jan. 27, 2021, the entire contents of which are incorporated herein by reference.

What is claimed is:

1. A casing device adapted to be disposed in a prescribed space that is opened/closed by an opening/closing body, comprising:
a casing having a housing section adapted to house an electronic key configured to cause a control device to perform control of a controlled device based on first wireless communication including reception of a first signal using a first frequency band and transmission of a second signal using a second frequency band as a response to the first signal, and being formed of a material capable of blocking the second frequency band;
an actuator configured to actuate a movable portion of the electronic key housed in the housing section;
a transceiver configured to receive, based on second wireless communication, a trigger signal from a mobile device adapted to be carried by a user; and
a controller configured to control an operation of the actuator,
wherein a part of the casing is configured to be switchable between a state that the second signal is allowed to pass and a state that the second signal is not allowed to pass; and
wherein the controller is configured to switch the part of the casing into the state that the second signal is allowed to pass, and to cause the actuator to actuate the movable portion so as to cause the electronic key to transmit the second signal, in a case where the transceiver receives the trigger signal.

2. The casing device according to claim 1, comprising:
a first antenna disposed outside the casing and having sensitivity in the second frequency band;
a second antenna disposed inside the casing and having sensitivity in the second frequency band; and
a switch configured to switch between a state that the first antenna and the second antenna are electrically connected and a state that the first antenna and the second antenna are electrically isolated,
wherein the part of the casing includes a conductive path formed by electrically connecting the first antenna and the second antenna; and
wherein the controller is configured to cause the switch to form the conductive path in the case where the transceiver receives the trigger signal.

3. The casing device according to claim 1,
wherein the part of the casing includes an aperture and a lid capable of opening/closing the aperture; and
wherein the controller is configured to cause the lid to open the aperture in the case where the transceiver receives the trigger signal.

4. The casing device according to claim 2,
wherein the controller is configured to switch the part of the casing into the state that the second signal is not allowed to pass after causing the actuator to actuate the movable portion.

5. The casing device according to claim 3,
wherein the controller is configured to switch the part of the casing into the state that the second signal is not allowed to pass after causing the actuator to actuate the movable portion.

6. The casing device according to claim 1,
wherein the casing is formed of a material capable of allowing the first frequency band to permeate.

7. The casing device according to claim 1,
wherein the transceiver includes an antenna disposed outside the casing, and is configured to perform the second wireless communication with the second frequency band.

8. A remote control system, comprising:
a casing device adapted to be disposed in a prescribed space that is opened/closed by an opening/closing body;
a control device configured to perform control of a controlled device; and
an electronic key configured to cause the control device to perform the control of the controlled device based on first wireless communication including reception of a first signal using a first frequency band and transmission of a second signal using a second frequency band as a response to the first signal,
wherein the casing device includes:
a casing having a housing section adapted to house the electronic key, and being formed of a material capable of blocking the second frequency band;
an actuator configured to actuate a movable portion of the electronic key housed in the housing section;
a transceiver configured to receive, based on second wireless communication, a trigger signal from a mobile device adapted to be carried by a user; and
a controller configured to control an operation of the actuator,
wherein a part of the casing is configured to be switchable between a state that the second signal is allowed to pass and a state that the second signal is not allowed to pass; and
wherein the controller is configured to switch the part of the casing into the state that the second signal is allowed to pass, and to cause the actuator to actuate the movable portion so as to cause the electronic key to transmit the second signal, in a case where the transceiver receives the trigger signal.

9. The remote control system according to claim 8,
wherein the controlled device includes a locking/unlocking device configured to lock/unlock the opening/closing body.

10. The remote control system according to claim 8,
wherein the control device and the controlled device are installed in a mobile entity.
